(19) United States
(12) Patent Application Publication
(10) Pub. No.: US 2009/0176924 A1
(43) Pub. Date: Jul. 9, 2009

(54) PULVERULENT COMPOSITION BASED ON CARBON NANOTUBES, METHODS OF OBTAINING THEM AND ITS USES, ESPECIALLY IN POLYMERIC MATERIALS

(75) Inventors: Serge Bordere, Jurancon (FR); Sylvain Bourrigaud, Pau (FR); Sylvie Cazaumayou, Dax (FR); Laurence Couvreur, Pau (FR); Nour Eddine El Bounia, Orthez (FR); Nicolas Passade-Boupat, Pau (FR); Patrick M. Piccione, Pau (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 12/095,240

(22) PCT Filed: Nov. 29, 2006
(86) PCT No.: PCT/FR2006/051258

§ 371 Date: Sep. 26, 2008

Related U.S. Application Data
(60) Provisional application No. 60/785,362, filed on Mar. 23, 2006.

(30) Foreign Application Priority Data
Nov. 30, 2005 (FR) 0512188
Apr. 20, 2006 (FR) 0603489

(51) Int. Cl. C08K 3/04; B82B 1/00; B82B 3/00

(52) U.S. Cl. 524/495; 977/742; 977/842; 977/840

(57) ABSTRACT

The present invention relates to pulverulent compositions based on carbon nanotubes which exhibit an excellent dispersibility in polymer materials and can advantageously be used as reinforcing agents and/or modifiers of conducting and/or thermal properties; they can be easily incorporated in polymer matrices in the masterblend form.

The present invention relates to materials based on carbon nanotubes (CNT) and more particularly to CNT-based pulverulent compositions.

Carbon nanotubes are composed of graphite sheets wound up and terminated by hemispheres composed of pentagons and hexagons with a structure similar to that of fullerenes and exhibit a tubular structure with a diameter of between 0.4 and 50 nm, preferably of less than 100 nm, and with a very high length/diameter ratio, typically of greater than 10 and generally of greater than 100.

A distinction is made between nanotubes composed of a single sheet (the term is then SWNT (single wall nanotubes)) and nanotubes composed of several concentric sheets, then referred to as MWNT (multi wall nanotubes), SWNTs generally being regarded as more difficult to manufacture than MWNTs.

Processes for the synthesis of CNTs are well known: mention may be made of WO 86/03455A1 from Hyperion Catalysis International Inc., corresponding to EP 225 556 B1, which can be regarded as one of the fundamental patents on the synthesis of CNTs of MWNT type. Other documents claim process improvements, such as the use of a continuous fluidized bed which makes it possible to control the state of aggregation of the catalyst and of the carbonaceous materials formed (see, for example, WO 02/94713A1 on behalf of the University of Tsinghua), or product improvements, such as, for example, WO 02/095097 A1 on behalf of Trustees Of Boston College, which provides nanotubes of varied and nonaligned morphology by varying the nature of the catalyst and the reaction conditions.

On conclusion of the synthesis, CNTs are obtained in the powder form (the CNTs are attached to the grains of catalyst in the form of an intertwined network) with a particle size generally of greater than or equal to 300 μm.

The CNTs are used for their excellent electrical and thermal conductivity properties and their mechanical properties (reinforcing agents, and the like). They are thus increasingly used as additives for contributing electrical, thermal and/or mechanical properties to materials, in particular those of macromolecular type, but an impediment to their development, in addition to their high cost in comparison with other additives contributing one and/or other of these properties, is that they are difficult to disperse and to handle because of their low size and their pulverulence.

Not much is yet known about CNTs as regards the HSE (health-safety-environment) aspects. While awaiting detailed studies, it is preferable, by way of precaution, to avoid handling “bare” CNTs, for example resulting directly from the synthesis.

There exists an unsatisfied demand to employ CNTs which are easier to handle, in particular industrially, than those resulting from the synthesis proper while exhibiting less or nothing in the way of fines.

There also exists an unsatisfied demand to improve the dispersibility of CNTs in the materials, in particular polymers, in which they are incorporated, in order to obtain more homogeneous materials.

In attempting to solve the problem of the dispersibility of CNTs, recourse has been had to one or other of the numerous solvent-route mixing techniques for positioning, at the surface of the nanotubes, agents (polymers, surfactants or others) which serve to help in the dispersing, such as, for example, in EP1 495 171.

Another route consists in producing a dispersion of CNT in a solvent and a monomer, which monomer is subsequently polymerized in situ, and in some cases such a route makes it possible to functionalize the CNTs, as disclosed in EP 1 359 121 and EP 1 359 169.

However, these various techniques exhibit the following disadvantages: the mixtures or polymerizations are carried out in the presence of solvent(s) and/or in a medium which is very dilute in CNT (generally less than 20 parts by weight), which results in the applications of these CNT solutions being limited in particular to cases which are compatible with the large amount of solvent(s) used, which high content subsequently has to be removed. This also results in the need to incorporate a large amount of dispersing agent in order to introduce a significant amount of CNT.

Bulk polymerizations in the presence of CNT are described in the literature, as in the paper Macromol. Rapid Commun., 2003, 24, vol. 18, 1070-1073, by Park et al. These various techniques also have the disadvantage of being restricted to very low levels of CNT, very frequently less than 20%.

Provision has also been made in EP 692 136, in order to solve the problems of dispersibility of CNTs, for masterblends based on polymeric materials which can comprise up to 60% of CNT by the melt route in high shear devices of extruder type; however, in the examples of EP 692 136, the CNT concentration of the masterblends never exceeds 20%.

The present invention relates to CNT-based compositions which are provided in the powder form but which do not exhibit the HSE disadvantages of crude CNTs, for example resulting directly from the synthesis, set out above.

In comparison with crude CNTs resulting from the synthesis, the pulverulent compositions of the invention exhibit the advantage of having a higher density and of presenting a better dispersibility in polymer matrices than those of the prior art, while avoiding the handling of crude CNT powders.

Unlike the masterblends of the prior art comprising CNTs, the compositions according to the invention can comprise a very high level of CNT while retaining excellent properties of dispersing when they are incorporated in materials, in particular polymers.

Another subject-matter of the invention is processes for obtaining these pulverulent compositions and the uses of these compositions.

Unless otherwise indicated, the percentages in the present text are percentages by weight.

The pulverulent compositions according to the invention comprise from 20% to 95% of CNT, particularly from 35% to 90% of CNT, and for example from 40% to 90% of CNT. The mean size of the particles of the pulverulent compositions according to the invention is generally less than or equal to 1 mm, preferably less than or equal to 800 μm. Preferably, at most 10% and advantageous at most 5% of the particles of the compositions according to the invention have a size of less than 40 μm, measured in particular by dry sieving on a vibrating sieve.

The composition according to the invention as defined above can additionally comprise one or more other pulverulent fillers other than the CNTs. Mention may be made, as example of fillers, of carbon blacks, active charcoals, silicas, glass fibres, pigments, clays, calcium carbonate, nanotubes formed of boron and/or nitrogen and/or of transition metals.

Another subject-matter of the present invention is a process for the preparation of these pulverulent compositions.

The process according to the invention for preparing the pulverulent compositions defined above comprises:
a) a stage of bringing the CNTs into contact/dispersing the CNTs with at least one compound A,
b) optionally a stage consisting of a heat treatment,
c) optionally a stage of purification and/or separation of the composition from the reactants for the purpose of its recovery,
   the mixture obtained on completion of each of stages a), b) and c) remaining in the powder form.

Stage a) consists in dispersing the CNTs with at least one compound A which acts as dispersing agent. In that which follows, for simplicity, the expression “compound A” can correspond to one or to several compounds A.

According to the invention, the content of compound A in the pulverulent composition is such that the sum of the contents of CNT and optionally the other pulverulent fillers represents the remainder to 100%. In particular, the compound A or the mixture of compounds A represents from 5 to 80%, in particular from 5 to 65%.

The compound A can be a monomer, a mixture of monomers, a molten polymer or a blend of molten polymers, a solution of monomer(s) and/or of polymer(s) in a solvent, one or more polymers in solution in one or more monomers, a nonreactive entity of oil type or of plasticizer type, an emulsifying or surface-active agent, a coupling agent (intended in particular to promote the dispersing of filler in an elastomeric composition) and/or a carboxylic acid.

The document FR 2 870 251 discloses the use as compatibilizing agent of a block copolymer obtained by controlled radical polymerization and exhibiting at least one block carrying acid and/or anhydride functional groups for the production of stable dispersions of carbon nanotubes in organic or aqueous solvents or in polymer matrices. The process disclosed in this document differs from that of the present invention, inter alia, in that the mixture is not in the powder form on conclusion of each of the stages but in the solution form. Furthermore, this document discloses only the CNT/copolymer ratio and not the CNT content in the final composition, which corresponds to a very broad range of CNT content. In other words, this document neither discloses nor suggests to a person skilled in the art pulverulent compositions with high CNT content, the stages for the preparation of which are carried out solely in the powder form.

The term “polymer according to the invention” also covers oligomers; the term “solution” covers not only the mixtures where the compounds are miscible and form only a single phase but also immiscible mixtures, such as emulsions, suspensions or others.

The term “monomer which can be used as compound A according to the invention” is understood to mean equally the monomers which can be (co)polymerized by the radical or anionic or cationic ionic route or by polycondensation or polyaddition, it being understood that some monomers can be polymerized independently of one another according to one or more of these polymerization techniques.

Mention may be made, among the monomers capable of polymerizing by the radical route which can be used as compounds A, of monomers exhibiting a carbon-carbon double bond, such as vinyl, preferably vinyl chloride, vinylidene, diene and olefinic, allyl, acrylic or methacrylic monomers, and the like. Mention may in particular be made of vinylaromatic monomers, such as styrene or substituted styrenes, in particular α-methylstyrene and sodium styrenesulphonate, dienes, such as butadiene, isoprene or 1,4-hexadiene, acrylic monomers, such as acrylic acid or its salts, alkyl, cycloalkyl or aryl acrylates, such as methyl, ethyl, butyl, ethylhexyl or phenyl acrylate, hydroxyalkyl acrylates, such as 2-hydroxyethyl acrylate, ether alkyl acrylates, such as 2-methoxyethyl acrylate, alkoxy- or aryloxypolyalkylene glycol acrylates, such as methoxypolyethylene glycol acrylates, ethoxypolyethylene glycol acrylates, methoxypolypropylene glycol acrylates, methoxypolyethylene glycol-polypropylene glycol acrylates or their mixtures, aminoalkyl acrylates, such as 2-(dimethylamino)ethyl ethyl acrylate (ADAME), acrylates of amine salts, such as [2-(acryloyloxy)ethyl]trimethylammonium chloride or sulphate or [2-(acryloyloxy)ethyl]dimethylbenzylammonium chloride or sulphate, fluoroacrylates, silylated acrylates or phosphorus-comprising acrylates, such as alkylene glycol acrylate phosphates, methacrylic monomers, such as methacrylic acid or its salts, alkyl, cycloalkyl, alkenyl or aryl methacrylates, such as methyl, lauryl, cyclohexyl, allyl or phenyl methacrylate, hydroxyalkyl methacrylates, such as 2-hydroxyethyl methacrylate or 2-hydroxypropyl methacrylate, ether alkyl methacrylates, such as 2-ethoxyethyl methacrylate, alkoxy- or aryloxypolyalkylene glycol methacrylates, such as methoxypolyethylene glycol methacrylates, ethoxypolyethylene glycol methacrylates, methoxypolypropylene glycol methacrylates, methoxypolyethylene glycol-polypropylene glycol methacrylates or their mixtures, aminoalkyl methacrylates, such as 2-(dimethylamino)ethyl methacrylate (MADAME), methacrylates of amine salts, such as [2-(methacryloyloxy)ethyl]trimethylammonium chloride or sulphate or [2-(methacryloyloxy)ethyl]dimethylbenzylammonium chloride or sulphate, fluoromethacrylates, such as 2,2,2-trifluoroethyl methacrylate, silylated methacrylates, such as 3-methacryloyloxypropyltrimethylsilane, phosphorus-comprising methacrylates, such as alkylene glycol methacrylate phosphates, hydroxyethylimidazolidone methacrylate, hydroxyethylimidazolidinone methacrylate or 2-(2-oxo-1-imidazolidinyl)ethyl methacrylate, acrylonitrile, acrylamide or substituted acrylamides, 4-acryloylmorpholine, N-methylolacrylamide, acrylamidopropyltrimethylammonium chloride (APTAC), acrylamidomethylpropane-sulphonic acid (AMPS) or its salts, methacrylamide or substituted methacrylamides, N-methylolmethacrylamide, methacrylamidopropyltrimethylammonium chloride (MAPTAC), itaconic acid, maleic acid or its salts, maleic anhydride, alkyl or alkoxy- or aryloxypolyalkylene glycol maleates or hemimaleates, vinylpyridine, vinylpyrrolidinone, (alkoxy)poly(alkylene glycol) vinyl ethers or divinyl ethers, such as methoxypoly(ethylene glycol) vinyl ether or poly(ethylene glycol) divinyl ether, olefinic monomers, among which may be mentioned ethylene, propylene, butene, hexene and 1-octene, as well as fluoroolefinic monomers and vinylidene monomers, among which may be mentioned vinylidene fluoride, preferably vinylidene chloride, alone or as a mixture of at least two abovementioned monomers.

The radical polymerization may or may not be carried out in the presence of at least one polymerization initiator chosen, for example, from organic or inorganic peroxides, azo compounds, redox pairs and/or alkoxyamines.

Mention may be made, as examples of monomers according to the invention which can be used as compounds A, of carboxylic monomers, their salts and their anhydrides, vinyl esters of saturated or unsaturated carboxylic acids, such as, for example, vinyl acetate or propionate; amino acids, such as aminocaproic, 7-aminoheptanoic, 11-aminoundecanoic and 12-aminododecanoic acids, lactams, such as caprolactam, oenantholactam and lauryllactam; or salts or mixtures of diamines, such as hexamethylenediamine, dodecamethylenediamine, metaxylylenediamine, bis(p-aminocyclohexyl)methane and trimethylhexamethylenediamine, with diacids, such as isophthalic, terephthalic, adipic, azelaic, suberic, sebacic and dodecanedicarboxylic acids.

The term “monomer which can be used as compound A according to the invention” is also understood to mean the monomers of epoxy resin type which can be polymerized by ring opening, such as aliphatic glycidyl esters and ethers, such as allyl glycidyl ether, vinyl glycidyl ether, glycidyl maleate, glycidyl itaconate and glycidyl (meth)acrylate, or alicylic glycidyl esters and ethers, such as 2-cyclohexen-1-yl glycidyl ether, diglycidyl cyclohexene-4,5-dicarboxylate, glycidyl cyclohexene-4-carboxylate, glycidyl 2-methyl-5-norbornene-2-carboxylate and diglycidyl endo-cis-bicyclo[2.2.1]hept-5-ene-2,3-dicarboxylate.

According to the invention, the compound A can also be a molten polymer, a mixture of molten polymers, one or more polymers in solution in a solvent and/or one or more polymers in solution in one or more monomers.

The term “polymer(s) which can be used as compound(s) A” is understood to mean, throughout what follows, any composition based on polymer(s) of any nature: thermoplastic or thermosetting, rigid or elastomeric, amorphous, crystalline and/or semicrystalline, homopolymeric, copolymeric, gradient, block, random or sequential; these compositions can be blends of one or more polymers with one or more additives, adjuvants and/or fillers conventionally added to polymers, such as stabilizers, plasticizers, polymerization catalysts, dyes, pigments, lubricants, flame retardants, reinforcing agents and/or fillers, polymerization solvents, and the like.

The polymers can be obtained without limitation from one or more monomers listed above and/or from one or more other monomeric entities known to a person skilled in the art.

The term “polymer which can be used as compound A” is also understood to mean all the random, gradient or block copolymers produced from the homopolymers corresponding to the above description. This covers in particular the block copolymers produced via the anionic route of SBS, SIS, SEBS and SB type and the copolymers of SBM type (polystyrene-co-polybutadiene-co-poly(methyl methacrylate)). This also covers the copolymers produced by controlled radical polymerization, such as, for example, the copolymers of SBuAS type (polystyrene-co-poly(butyl acrylate)-co-polystyrene), MBuAM type (poly(methyl methacrylate)-co-poly(butyl acrylate)-co-poly(methyl methacrylate)) and all their functionalized derivatives.

The term “epoxy resin” is understood to mean, in the present description, any organic compound, alone or as a mixture, having at least two functional groups of oxirane type which can be polymerized by ring opening and denoting all conventional epoxy resins which are liquid at ambient temperature (20-25° C.) or at a higher temperature. These epoxy resins can on the one hand be monomeric or polymeric and, on the other hand, be aliphatic, cycloaliphatic, heterocyclic or aromatic. Mention may be made, as examples of such epoxy resins, of resorcinol diglycidyl ether, bisphenol A diglycidyl ether, triglycidyl-p-aminophenol, bromobisphenol F diglycidyl ether, m-aminophenoltriglycidyl ether, tetraglycidylmethylenedianiline, (trihydroxyphenyl)methane triglycidyl ether, polyglycidyl ethers of phenol-formaldehyde novolak, polyglycidyl ethers of ortho-cresol novolak and/or tetraglycidyl ethers of tetraphenylethane.

At least one second chemical entity, referred to as a hardener, can be added to the epoxy resin, which hardener is intended to provide the subsequent crosslinking of the epoxy resin by reacting with it. Mention may be made, as regards the hardener, of:
acid anhydrides, among which may be mentioned succinic anhydride;
aromatic or aliphatic polyamines, among which may be mentioned diaminodiphenyl sulphone (DDS), methylenedianiline, 4,4′-methylenebis(3-chloro-2,6-diethylaniline) (MCDEA) or 4,4′-methylenebis(2,6-diethylaniline) (MDEA);
dicyandiamide and its derivatives;
imidazoles;
polycarboxylic acids;
polyphenols.

In the case where the resin and the hardener are brought into contact simultaneously with the CNTs, it may be preferable to use the composition according to the invention before the epoxy resin and the hardener have reacted with one another.

Other monomers of thermosetting resins can also be used as compounds A, such as the monomers from which phenolic resins result, for example of the type of reactive alkylated methylphenol-formaldehyde and bromomethylphenol-formaldehyde resins, polyester or vinyl ester resins, or polyurethane resins. Examples of vinyl ester or unsaturated polyester resins are described in the paper by M. Malik et al. in J. M. S.—Rev. Macromol. Chem. Phys., C40 (2&3), p. 139-165 (2000), which describes a classification of such resins into five groups on the basis of their structure: (1) ortho resins, such as 1,2-propylene glycol, ethylene glycol, diethylene glycol, triethylene glycol, 1,3-propylene glycol, dipropylene glycol, tripropylene glycol, neopentyl glycol or hydrogenated bisphenol A, (2) iso resins, (3) bisphenol A fumarates, (4) chlorinated resins and (5) vinyl ester resins, such as vinyl ester resins of bisphenol A type, vinyl ester resins of novolak type, “mixed” vinyl ester resins having both types of units and halogenated vinyl ester resins.

Mention will very particularly be made, among the polymers which can be used as compound A according to the invention, of polystyrene (PS); polyolefins and more particularly polyethylene (PE) or polypropylene (PP); polyamides (for example, PA-6, PA-6,6, PA-11 or PA-12); poly(methyl methacrylate) (PMMA); poly(ethylene terephthalate) (PET); polyethersulfones (PESs); polyphenylene ether (PPE); poly(vinylidene fluoride) (PVDF); polystyrene-acrylonitrile (SAN); polyetheretherketones (PEEKs); poly(vinyl chloride) (PVC); polyurethanes composed of flexible polyether blocks which are polyetherdiol residues and of rigid blocks (polyurethanes) which result from the reaction of at least one diisocyanate with at least one short diol; it being possible for the chain-extending short diol to be chosen from the glycols mentioned above in the description; the polyurethane blocks and the polyether blocks being connected via bonds resulting from the reaction of the isocyanate functional groups with the OH functional groups of the polyetherdiols; polyesterurethanes, for example those comprising diisocyanate units, units derived from amorphous polyesterdiols and units derived from a chain-extending short diol chosen, for example, from the glycols listed above; copolymers comprising polyamide blocks and polyether blocks (PEBA) resulting from the copolycondensation of polyamide sequences comprising reactive ends with polyether sequences comprising reactive ends, such as, inter alia, 1) polyamide sequences comprising diamine chain ends with polyoxyalkylene sequences comprising dicarboxyl chain ends, 2) polyamide sequences comprising dicarboxyl chain ends with polyoxyalkylene sequences comprising diamine chain ends obtained by cyanoethylation and hydrogenation of aliphatic α,ω-dihydroxylated polyoxyalkylene sequences, known as polyetherdiols, 3) polyamide sequences comprising dicarboxyl chain ends with polyetherdiols, the products obtained being, in this specific case, polyetheresteramides; or polyetheresters.

The polymers which can be used as compounds A can be polymers comprising functional groups of epoxide and/or glycidyl ether type, of saturated or unsaturated, aromatic or nonaromatic, mono-, di- or polycarboxylic acid or functional derivative of acid, such as anhydride, ester, amide and/or imide, type, of vinyl or vinylaromatic type, and the like, it being understood that the definitions of the polymers given above may be redundant insofar as some polymers comprise several of the functional groups listed above.

According to the invention, the compound A is in particular a polymer in solution in a solvent resulting from the polymerization or copolymerization of a monomer of (meth)acrylic acid, more particularly resulting from the copolymerization of (meth)acrylic acid and of an oxyalkylene monomer, in particular oxyethylene.

According to another embodiment of the invention, the compound A is a polymer in solution in a solvent resulting from the polymerization of alkyl (methyl, ethyl, propyl, butyl, in particular) (meth)acrylate with styrene and/or butadiene.

The term “nonreactive entity which can be used as compound A according to the invention” is understood to mean any type of oil or any type of liquid plasticizer used in the polymers industry. Mention may be made, for example, of:
hydrocarbon oils of animal origin, such as perhydrosqualene (or squalane);
hydrocarbon oils of vegetable origin, such as liquid triglycerides of fatty acids, the fatty acids of which comprise from 4 to 22 carbon atoms and in particular from 4 to 10 carbon atoms, such as triglycerides of heptanoic acid or octanoic acid, or also oils of vegetable origin, for example sunflower, maize, soybean, cucumber, grape seed, sesame, hazelnut, apricot, macadamia, arara, coriander, castor or avocado oils, jojoba oil, or shea butter oil, or also triglycerides of caprylic/capric acids, such as those sold by Stéarineries Dubois or those sold under the trade names Miglyol 810, 812 and 818 by Dynamit Nobel;
synthetic esters and ethers, in particular of fatty acids, such as oils of formulae RICOOR2 and R1OR2 in which R1 represents the residue of a fatty acid comprising from 8 to 29 carbon atoms and R2 represents a linear or branched hydrocarbon chain comprising from 3 to 30 carbon atoms, such as, for example, purcellin oil, isononyl isononanoate, isopropyl myristate, 2-ethylhexyl palmitate, 2-octyldodecyl stearate, 2-octyldodecyl erucate or isostearyl isostearate;
hydroxylated esters, such as isostearyl lactate, octyl hydroxystearate, octyldodecyl hydroxystearate, diisostearyl malate, triisocetyl citrate, heptanoates, octanoates or decanoates of fatty alcohols; polyol esters, such as propylene glycol dioctanoate, neopentyl glycol diheptanoate and diethylene glycol diisononanoate;
pentaerythritol esters, such as pentaerythrityl tetraisostearate; lipophilic derivatives of amino acids, such as isopropyl lauroyl sarcosinate (INCI name), sold under the name Eldew SL 205 by Ajinomoto;
linear or branched hydrocarbons of mineral or synthetic origin, such as mineral oils (mixture of hydrocarbon oils derived from oil; INCI name: mineral oil), volatile or nonvolatile liquid paraffins and their derivatives, liquid petrolatum, polydecenes, isohexadecane, isododecane, hydrogenated isoparaffin, such as Parleam® oil, sold by NOF Corporation (INCI name; hydrogenated polyisobutene);
silicone oils, such as volatile or nonvolatile polymethylsiloxanes (PDMSs) comprising a linear or cyclic silicone chain which are liquid or pasty at ambient temperature, in particular cyclopolydimethylsiloxanes (cyclomethicones), such as cyclopentasiloxane and cyclohexadimethylsiloxane;
polydimethylsiloxanes comprising pendant alkyl, alkoxy or phenyl groups or alkyl, alkoxy or phenyl groups at the end of the silicone chain, which groups have from 2 to 24 carbon atoms; phenylated silicones, such as phenyl trimethicones, phenyl dimethicones, phenyl(trimethylsiloxy)diphenylsiloxanes, diphenyl dimethicones, diphenyl(methyldiphenyl)trisiloxanes, (2-phenylethyl)trimethylsiloxysilicates and polymethylphenylsiloxanes;
fluorinated oils, such as those which partially comprise hydrocarbon and/or silicone, such as those disclosed in document JP-A-2-295912;
ethers, such as dicaprylyl ether (CTFA name); and 35 benzoates of C₁₂-C₁₅ fatty alcohols (Finsolv TN from FINETEX);
their mixtures.

Mention may also be made of oils of trimellitate type, such as trioctyl trimellitate, or of predominantly naphthenic oils, such as Catenex N956 oil from Shell, oils of paraffin type (typically Primol 352 from Exxon-Mobil) or of liquid polybutene type (typically Napvis 10) and products of resorcinol bis(diphenyl phosphate) (RDP) type which act as plasticizer while contributing additional properties, such as an improved fire resistance.

External plasticizers commonly used in the conversion of plastics can also be used as compound A according to the invention. Mention may be made, as nonlimiting examples, of: octadecanol or fatty acids, such as stearic acid or palmitic acid.

The term “emulsifying agent which can be used as compound A according to the invention” is understood to mean any anionic, cationic or nonionic surfactant. The emulsifying agent can also be an amphoteric or quaternary or fluorinated surfactant. It can, for example, be chosen from alkyl or aryl sulphates, alkyl- or arylsulphonates, fatty acid salts, poly(vinyl alcohol)s or polyethoxylated fatty alcohols.

By way of example, the emulsifying agent can be chosen from the following list:
sodium lauryl sulphate,
sodium dodecylbenzenesulphonate,
sodium stearate,
polyethoxylated nonylphenol,
dihexyl sodium sulphosuccinate,
dioctyl sodium sulphosuccinate,
lauryldimethylammonium bromide,
lauryl amido betaine,
potassium perfluorooctylacetate.

The emulsifying agent can also be a block or random or grafted amphilphilic copolymer, such as sodium styrenesulphonate copolymers and in particular polystyrene-b-poly(sodium styrenesulphonate), or any amphiphilic copolymer prepared by any other polymerization technique.

The compound A according to the invention can also be chosen from coupling agents intended to promote the dispersing of filler in an elastomeric composition and in particular the poly(alkylphenol) polysulphides disclosed in WO 05/007738, the content of which is incorporated by reference; mention may also be made, as coupling agents, of the polysulphide organosilane derivatives disclosed in EP 501.227, in WO 97/42256 and in WO 02/083719.

The compound A according to the invention can also be a carboxylic acid. The term “carboxylic acid” is understood to mean a compound comprising at least one carboxylic acid functional group. Mention may be made, by way of example, of acetic acid, acrylic acid or methacrylic acid, alone or as a mixture.

According to the invention, the compound A can be one or more monomers and/or one or more polymers in solution in a solvent. This solvent can be chosen from water, cyclic or linear ethers, alcohols, ketones such as methyl ethyl ketone, aliphatic esters, acids, such as, for example, acetic acid, propionic acid or butyric acid, aromatic solvents, such as benzene, toluene, xylenes or ethylbenzene, halogenated solvents, such as dichloromethane, chloroform or dichloroethane, alkanes, such as pentane, n-hexane, cyclohexane, heptane, octane, nonane, dodecane or isododecane, amides, such as dimethylformamide (DMF), or dimethyl sulphoxide (DMSO), alone or as a mixture.

According to the invention, the compounds A can be in the gas, liquid and/or solid form.

The CNTs can be brought into contact (stage a)) with the compound A in various ways and in particular by dispersion, adsorption or mixing:
In the case where the compound A is in the liquid form, the operation in which the CNT powder is brought into contact with A corresponds, for example, to a dispersing, either by direct introduction by pouring the compound A into the powder (or the reverse), or by dropwise introduction of compound A into the CNT powder, or by nebulizing compound A over the CNT powder using a sprayer.

The dispersing method can also be performed by pouring the CNT powder into the solution of compound A, which may or may not be put into the form of a fluid film or of fine droplets (dew) deposited on a solid surface.
In the case where the compound A is in the gas form, the operation in which the CNT powder is brought into contact with A corresponds to adsorption of vapours of A which are or are not transported by a gas, preferably an inert gas.
In the case where the compound A is in the solid form, the operation in which the CNT powder is brought into contact with A corresponds to a dry blending of powders and has to be followed by stage b) (heat treatment), where A is converted to the liquid or gas form in order to ensure the intimate and homogeneous mixing of the compound A with the CNTs.

The dispersing between the CNTs and the compound A can also be carried out using a preliminary stage in which the compound A is dissolved in the presence of the CNTs in a solvent.

In this case, this preliminary stage will be followed by a phase of evaporation of the solvent preferably carried out with stirring so as to recover the composition in the powder form. Use may advantageously be made of a filtration process, so as to accelerate the time of the cycle targeted at obtaining the compound A and CNT powder composition in the dry form.

In the case where compounds A of different physical form are introduced, the operation in which the compounds of different physical form are brought into contact with the CNTs will preferably be carried out successively; for example, adsorption of compound(s) A in the gas form on the CNTs and then dry blending with a 2nd compound A in the solid form or in the liquid form.

This stage a) can be carried out in conventional synthesis reactors, in fluidized bed reactors or in mixing devices of Z arm mixer, Brabender or extruder type, or any other mixing device of the same type known to a person skilled in the art.

On completion of this first stage a), the mixture between the CNTs and the compound A remains in the form of a solid powder and retains good flowability properties (it does not set solid). If necessary, it may or may not be mechanically stirred.

The amount of compound A introduced is such that, on completion of this stage a), it is below the threshold at which there is obtained either a liquid suspension of CNT or a paste in which the CNT grains are completely or partially pasted together. This threshold depends in particular on the ability of the compound A to impregnate the CNT powder and, in the case where A is a liquid or a solution, on the viscosity of the liquid introduced.

In the case where the compound A is acrylic acid, the compound A content is generally between 30 and 90%.

The process for producing the compositions according to the invention comprises an optional stage b) which consists of a heat treatment on the powder resulting from stage a).

This heat treatment consists in heating up the powder obtained after stage a) so that the physicochemical properties of the powder are modified by this heat treatment.

In the case where a liquid comprising monomers has been introduced in stage a) (monomer(s) in the liquid state, solution of monomer(s), and the like), this heat treatment stage can consist, for example, of a heating which allows the monomers to polymerize and/or a strong physical adsorption and/or a chemical adsorption with creation of bonds between the CNTs and a fraction of the monomers or of the polymer or polymers formed.

The bond between the CNT and the polymer synthesized in situ via the monomers introduced in the first stage or the polymer added during the first stage is characterized in that a portion of this polymer, created in situ or added to the CNTs before the heat treatment of stage b), can no longer be extracted from the CNT by various washing operations with solvents selected for the polymer, whereas the same washing operations on the mixture (CNT/compound A) resulting from stage a) make it possible to extract all the compound A from the CNTs.

In the case where a solution of (co)polymer(s) was used in stage a), the heat treatment stage b) makes it possible to obtain strong physical adsorption and/or chemical adsorption with creation of covalent bonds between the CNTs and the polymer and/or the continuation of the polymerization, with, for example, an increase in the molar mass of the polymer.

In the case where the compound A is in the liquid form or in solution in a solvent, stage b) can also make it possible to improve the distribution between the liquid and the CNTs.

When it is desired that polymerization should take place during stage b), the pressure and temperature conditions of this heat treatment stage will be in agreement with the usual conditions for polymerization known to a person skilled in the art. The atmosphere during the polymerization may or may not be inert, depending on the nature of the monomers and of the polymers concerned.

When the compound A is (meth)acrylic acid, its polymerization during stage b) is carried out at a pressure generally of between 0 and 3 bar and at a temperature between 40 and 150° C. The heating time is then between 5 and 1000 min and more specifically between 300 and 600 min. Advantageously, the heat treatment (stage b)) is carried out according to the following heat cycle: first a stationary phase at 64° C. for 150 to 500 min, followed by a second stationary phase at 120° C. for 100 to 200 min, before cooling to ambient temperature; the pressure remains substantially equal to atmospheric pressure.

On completion of stage b), the product (mixture) obtained remains in the form of a solid powder and retains good flowability properties (it has not set solid). On completion of this stage, the product obtained, like that resulting from stage a), is below the threshold at which there is obtained either a liquid suspension of CNT or a paste in which the CNT grains are completely or partially pasted together.

The process for producing the compositions according to the invention comprises an optional stage c) which consists of the optional separation of the compounds present in the CNT-based powder composition which are not bonded to the composition resulting from stage a) or b) by physical and/or chemical adsorption. This stage can, for example, consist of a washing operation using a solution comprising a solvent for the compounds to be removed and/or of a drying operation in order to devolatilize the volatile products. In order to bring the washing operation to a successful conclusion, it is possible, for example, to use a mixture of solvents. The washing operation can be carried out in several stages, preferably between 1 and 5 stages, in order to improve the separation of the nonbonded compounds. It is also possible to combine several separating techniques, such as washing and drying.

The drying operation consists in placing the volatile compounds under temperature and pressure conditions such that their desorption is facilitated. Thus, it will preferably be possible to place under partial vacuum at a temperature lower than the temperature for chemical decomposition of the compounds, more particularly less than 200° C., and a pressure of between 100 Pa and 200 kPa.

In order to accelerate this extraction of the volatile compounds, it is also possible to begin with a first filtration phase. In this stage c), it is possible to carry out the final phase of drying, for example, with stirring in order to recover a nonagglomerated CNT powder, which would depart from the scope of the invention.

In the case of a process without stage b) where the compound A is (meth)acrylic acid, stage c) can consist of a washing operation with an aqueous alcohol solution and more particularly a 50% aqueous ethanol solution.

The compositions according to the invention can be used in numerous fields, in particular in electronics (depending on the temperature and their structure, they can be conducting, semiconducting or insulating), in mechanical systems, for example for the reinforcing of composite materials (CNTs are one hundred times stronger and six times lighter than steel), and in electromechanical systems (CNTs may expand or contract by injecting charge).

Mention may be made, for example, of materials intended, for example, for the packaging of electronic components, for example, for electromagnetic shielding and/or for antistatic dissipation, such as cases for mobile telephones, computers, electronic equipment installed in motor vehicles, trains and aircraft, for structural components for motor vehicles, trains and aircraft, for medical instruments, for fuel lines (petrol or diesel), for adhesive materials, for antistatic coatings, for thermistors, for electrodes, in particular for supercapacitors, and the like.

Given their excellent ability to disperse in polymers, the compositions according to the invention can advantageously be used as masterblends which are diluted in the final material, for example based on polymer(s).

The diluting of the composition according to the invention can be carried out in conventional synthesis reactors, in fluidized bed reactors or in mixing devices of Z arm mixer, Brabender or extruder type, in melting vessels when the polymer material is thermosetting, or any other mixing device of the same type known to a person skilled in the art.

### EXAMPLES

In all the examples, use was made of multiwall nanotubes (recorded as CNTs subsequently) obtained by the CVD (chemical vapour deposition) method on a catalytic support. A statistical study by transmission electron microscopy showed that virtually 100% of the tubes are multiwall with a diameter varying between 10 and 50 nm. Their electrical conductivity, when they are compressed in the pellet form, is greater than 20 S/cm. The level of ash, evaluated by calcination at 650° C. under air, is approximately 7%.

### Example 1

### Composition According to the Invention Based on CNT and Acrylic Acid (Impregnation by Spraying Acrylic Acid)

10 g of acrylic acid are incorporated into 10 g of CNT powder by spraying the acrylic acid solution using a sprayer of cosmetic fragrance atomizer type. The powder is stirred during the spraying using a mechanical stirrer of magnetic bar type in order to facilitate the satisfactory distribution of the acrylic acid (stage a)).

The powder obtained is subsequently heated in a sealed receptacle. The temperature follows the temperature cycle, which consists of a 1st temperature stationary phase at 64° C. for approximately 250 min, followed by a 2nd temperature stationary phase at 120° C. for approximately 100 min, before cooling to ambient temperature (stage b)).

The properties of the powder thus obtained (recorded as CNT1 a) are combined in Table 1.

The powder thus obtained is then washed and dried (stage c)). The washing operation is carried out using a solution of ethyl alcohol diluted to 50% in water. Two successive washing operations are carried out on the powder, which is filtered off each time using a Buchner filter funnel with a porosity of 11 μm. The powder thus obtained is then dried at 120° C. under a partial vacuum of 1000 Pa for 1 h.

The properties of the powder thus obtained (recorded as CNT1b) are combined in Table 1. The mean size of the particles of the CNT1b powder is 200 μm and the level of fines (<100 μm) is less than 2 % (measured by dry sieving on a vibrating sieve).

### Example 2

### Composition According to the Invention Based on CNT and Poly(Acrylic Acid) (Stage a)): Impregnation by Dropwise Pouring of an Acrylic Acid+Radical Initiator Mixture

A solution comprising 40 g of acrylic acid and 0.04 g of AIBN is incorporated in 10 g of CNT powder by running the solution in dropwise using a “Pasteur” pipette. The powder is stirred during the impregnation using a mechanical stirrer of magnetic bar type for 1 h in order to facilitate the satisfactory distribution of the acrylic acid.

The powder obtained is subsequently heated in a sealed receptacle. The temperature follows the temperature cycle of stage b) of Example 1 (stage b)).

The properties of the powder thus obtained (recorded as CNT 2a) are combined in Table 1.

The powder is subsequently dried at 120° C. under a partial vacuum of 1 kPa for 1 h (stage c)). A powder (recorded as CNT 2b) is thus obtained, the properties of which are combined in Table 1. Alternatively, it is possible to wash and dry the powder (recorded as CNT 2a) in order to extract the unreacted monomers and the polymer chains which have not been grafted to or irreversibly adsorbed on the CNTs. The washing operation is carried out using a solution of ethyl alcohol diluted to 50% in water. Two successive washing operations are carried out on the powder, which is filtered off each time using a Buchner filter funnel with a porosity of 11 μm. The powder thus obtained is then dried at 120° C. under a partial vacuum of 1 kPa for 1 h and it has the same properties as the powder recorded as CNT 2b.

### Example 3

### Impregnation by Adsorption of Acrylic Acid Vapours (Stage a)) and then Heat Treatment (Stage b))

A stream of nitrogen gas is bubbled at ambient temperature into a receptacle containing an acrylic acid solution. The vapours are subsequently introduced into a wash bottle containing CNTs by passing through a sintered glass, which makes it possible to suspend the CNTs and promote exchanges between the CNT powder and the gas vapours. The vapours are subsequently trapped in a receptacle cooled with liquid nitrogen. This vapour phase impregnation (stage a)) lasts 4 h. The properties of the powder thus obtained (recorded as CNT3a) are combined in Table 1.

The CNT3a powder is subsequently heated in a sealed receptacle. The temperature follows the temperature cycle of stage b) of Example 1 (stage b)). The properties of the powder thus obtained (recorded as CNT3b) are combined in Table 1.

The powder thus obtained is then washed and dried (stage c)). The washing operation is carried out using a solution of ethyl alcohol diluted to 50% in water. Two successive washing operations are carried out on the powder, which is filtered off each time using a BUchner filter funnel with a porosity of 11 μm. The powder thus obtained is then dried at 120° C. under a partial vacuum of 1 kPa for 1 h. The properties of the powder thus obtained (recorded as CNT3c) are combined in Table 1.

The percentage of CNT in the powder, the loose density of the powder and the conductivity of a PVDF sample comprising 2% or 1% of CNT, obtained by diluting the amount of composition necessary to obtain this concentration in the final mixture, are shown for each composition in Table 1.

The loose density of the powder is determined by measuring the volume occupied by 1 g of powder placed in a test tube after three successive slow inversions of the tube. Three measurements are carried out and the mean of the volume obtained is used to determine the density.

The dispersion in PVDF is prepared in the following way: mixtures of PVDF (Kynar® 720 from Arkema) with CNTs or CNT-based powder compositions as defined above are prepared using a Haake 90 Rheocord micromixer. The mixing conditions are as follows:
temperature of the mixture: 230° C.
rotor speed: 50 rev/min
blending time: 15 min

The samples are subsequently compression moulded at 230° C. Pellets are withdrawn using a hollow punch in order to measure conductivity. The conductivity tests are carried out on a device comprising a 4-wire cell.

TABLE 1

| | | | Mean resistivity of a | Mean resistivity of a |
|---|---|---|---|---|
| | | | mixture comprising | mixture comprising 1% |
| | CNT | Density | 2% of CNT in PVDF | of CNT in PVDF |
| Composition | (% by weight) | (g/ml) | (Ω · cm) | (Ω · cm) |
| CNT, pure | 100 | 0.09 | 209 | Nonconducting |
| CNT 1a | 50 | 0.18 | 14.5 | |
| CNT 1b | 82 | 0.11 | 38 | |
| CNT 2a | 20 | 0.4 | — | |
| CNT 2b | 79.6 | 0.12 | 11.5 | 3230 |
| CNT 3a | 77 | 0.118 | 68.09 | |
| CNT 3b | 77 | 0.105 | 13.29 | |
| CNT 3c | 77 | 0.108 | — | |

It emerges from the table that the compositions according to the invention disperse well in a polymer matrix; the distribution of the CNTs is homogeneous, which confers a lower electrical resistivity than that of compositions of the prior art.

### Example 4

### Composition According to the Invention Based on CNT and Acetic Acid (AcA), Methacrylic Acid (MAA) or a Mixture of Acrylic Acid (AA) and of Styrene (S) (Impregnation by Spraying Acetic Acid, Methacrylic Acid or a Mixture of Acrylic Acid and Styrene)

Samples of CNT powder are impregnated with various types of products according to the conditions described in Example 2. The powder is stirred during the impregnation using a mechanical stirrer of magnetic bar type for 1 h to facilitate the satisfactory distribution of the components. The details with regard to the mixtures are combined in Table 2 (stage a)).

TABLE 2

| Composition | % (CNT) | Compound A | % by weight of AIBN |
|---|---|---|---|
| CNT 4 | 50 | AcA | 0 |
| CNT 5 | 50 | MAA | 0 |
| CNT 6 | 20 | 50% AA/50% S | 0 |
| CNT 7 | 50 | MAA | 0.1 |
| CNT 8 | 20 | 50% AA/50% S | 0.1 |
| CNT 9 | 50 | AcA | 0 |

The powders thus obtained are subsequently heated in a sealed container at 80° C. for 4 hours and then at 125° C. for 70 minutes (stage b1)). It is confirmed, by retention of the weight, that all of the compound or compounds A introduced are indeed in the CNTs after stage 1. For some samples, a second confirmation is carried out by pyrolysis, it being ascertained that the percentage of catalyst in the sample is indeed in agreement with the level of CNT predicted. The properties of the powders thus obtained are determined and combined in Table 3. The powders thus obtained are then dried at 120° C. under a partial vacuum of 1 kPa for 1 h. The properties of the powders thus obtained are combined in Table 3 (stage b2)).

The powders thus obtained are then washed and dried (stage c)). The washing operation is carried out using a solution of ethyl alcohol diluted to 50% in water. Two successive washing operations are carried out on the powder, which is filtered off each time using a Buchner filter funnel with a porosity of 11 μm. The powders thus obtained are then dried at 120° C. under a partial vacuum of 1 kPa for 1 h. The properties of the powders thus obtained are combined in Table 3.

TABLE 3

| | | | | Density | Volume |
|---|---|---|---|---|---|
| | | | Density | (per 1 g of | (per 1 g of |
| Composition | Stage | CNT (%) | (g/ml) | pure CNT) | pure CNT) |
| CNT, pure | | 100 | 0.098 | 0.098 | 10.3 |
| | b1) | 50 | 0.125 | 0.063 | 16.0 |
| CNT 4 | b2) | 67 | 0.101 | 0.068 | 14.6 |
| | c) | 62 | 0.087 | 0.054 | 18.7 |
| | b1) | 50 | 0.200 | 0.100 | 10.0 |
| CNT 5 | b2) | 82 | 0.103 | 0.085 | 11.8 |
| | c) | 90 | 0.087 | 0.079 | 12.7 |
| | b1) | 20 | 0.400 | 0.080 | 12.5 |
| CNT 6 | b2) | 55 | 0.195 | 0.108 | 9.3 |
| | c) | 87 | 0.115 | 0.100 | 10.0 |
| | b1) | 50 | 0.200 | 0.100 | 10.0 |
| CNT 7 | b2) | 83 | 0.096 | 0.080 | 12.5 |
| | c) | 91 | 0.097 | 0.088 | 11.4 |
| | b1) | 20 | 0.444 | 0.089 | 11.3 |
| CNT 8 | b2) | 67 | 0.119 | 0.080 | 12.6 |
| | c) | 84 | 0.085 | 0.072 | 13.9 |
| | b1) | 50 | 0.118 | 0.059 | 17.0 |
| CNT 9 | b2) | 52 | 0.098 | 0.051 | 19.5 |
| | c) | 55 | 0.089 | 0.049 | 20.4 |

The resistivities with regard to the powder samples resulting from stage b2) as a mixture in PVDF are determined according to the methods described in Example 3 and are presented in Table 4 below:

TABLE 4

| | | Mean resistivity of a | Mean resistivity of a |
|---|---|---|---|
| | | mixture comprising | mixture comprising |
| | | 2% of CNT in PVDF | 1% of CNT in PVDF |
| Composition | Stage | (Ω · cm) | (Ω · cm) |
| CNT, pure | | 209 | Nonconducting |
| CNT 4 | b2) | 21 | |
| CNT 6 | b2) | 2.90E+04 | |
| CNT 7 | b2) | 240 | |
| CNT 9 | b2) | 6 | 1.58E+04 |

It emerges from the table that the compositions according to the invention disperse well in a polymer matrix; the distribution of the CNTs is homogeneous, which confers a lower electrical resistivity than that of compositions of the prior art.

### Example 5

### Composition According to the Invention Based on CNT and a Copolymer of (Meth)Acrylic Acid and of an Oxyethylenated Monomer Stage a): Mixture of CNT with the Polymer in Solution with Optionally Stage b): Subsequent Grafting

A mixture comprising 80 parts by weight of solution of DV1256 (solution of (meth)acrylic acid and of an oxyethylenated monomer) from Coatex disclosed in Patent FR 2 766 106, 100 parts by weight of CNT and 40 parts by weight of water is prepared in a Z arm mixer. The DV1256 is an aqueous solution comprising 25% by weight of copolymer.

A portion of the product obtained is dried under vacuum at ambient temperature to remove the water. When the powder resulting from this drying operation is washed according to the protocol described in Example 2, all the polymer is extracted from the CNT.

Another portion of the powder is dried at 100° C. for 5 h 30 min. When the powder resulting from this drying operation is washed according to the protocol described in Example 2, only 21% of the polymer is extracted from the CNT: 79% of the polymer introduced by the addition of DV1256 to the CNT appears to be grafted to or to be irreversibly adsorbed on the CNT.

### Example 6

### Mixtures of CNT with Various Compounds A with Mechanical Stirring

The operating conditions for each of the mixtures produced with a Rheocord micromixer (stage a)) are given in detail in Table 5 (temperature, blending rate and blending time) for each mixture. A total weight of 20 g is set in the mixer, the blending chamber of which has a volume of 66 cm³.

All the mixtures are prepared in the following way:

1. Two thirds of the CNT is introduced into the blending chamber, where it occupies all the volume available.

2. The polymer is added in small successive amounts, which has the effect of reducing the overall volume of the CNT.

3. It is then possible to add the remaining third of the CNT to the mixture.

TABLE 5

| | | Blending | Blending | |
|---|---|---|---|---|
| | | temperature | time | Density |
| Compound A | % CNT | (° C.) | (min) | (g/ml) |
| None (control CNT | 100 | 25 | 0 | 0.09 |
| resulting from the | | | | |
| synthesis) | | | | |
| None (control CNT | 100 | 25 | 30 | 0.1 |
| after blending) | | | | |
| PMMA HT121 | 50 | 210 | 30 | 0.22 |
| 35BA320 | 50 | 80 | 30 | |
| M22 | 50 | 180 | 30 | 0.22 |
| M22N | 50 | 180 | 30 | 0.23 |
| D320 | 50 | 180 | 30 | 0.17 |
| DER332 | 50 | 60 | 30 | 0.27 |
| PAA GE1903 | 50 | 25 | 30 | 0.31 |
| Vultac TB7 | 50 | 140 | 30 | 0.22 |
| Evatane 2803 | 50 | 180 | 30 | 0.22 |
| SBM E40 | 50 | 180 | 30 | 0.24 |
| Evazole | 50 | 40 | 30 | 0.29 |
| Primol 352 | 50 | 25 | 30 | 0.24 |
| DER332 | 75 | 60 | 30 | 0.17 |
| PAA GE1903 in water | 75 | 25 | 30 | 0.18 |
| Noram M2C | 50 | 25 | 30 | 0.29 |

HT 121 is a PMMA grade from Arkema with a melt flow index (MFI) equal to 2 measured at 230° C. under 3.8 kg and with a Vicat temperature of 121° C. under 50N according to Standard ISO 306.

35BA320 is an ethylene-butyl acrylate Lotryl® functionalized polyolefin from Arkema with an MFI measured for 10 min between 260 and 350.

MAM M22 and M22N are poly(methyl methacrylate)-poly(butyl acrylate)-poly(methyl methacrylate) (MAM) copolymers from Arkema, the viscosity of which in solution at 10% in toluene is of the order of 8 cP for M22 and respectively of the order of 15 cP for M22N.

SBM E40 is a polystyrene-polybutadiene-poly(methyl methacrylate) (SBM) copolymer from Arkema, the viscosity of which in solution at 10% in toluene is of the order of 4 cP.

D320 is an acrylic impact modifier of core-shell type from Arkema.

DER 332 is a bisphenol A diglycidyl ether (BADGE) monomer from Dow of high purity (epoxide equivalent weight of 171 to 175 g/eq.) and with a viscosity of approximately 5 Pa·s at ambient temperature.

PM GE1903 in water is a PM in aqueous solution from Coatex.

Vultac TB7 is a coupling agent according to WO 05/007738 from Arkema.

Evatane 2803 is a copolymer of ethylene and of vinyl acetate (EVA) from Arkema comprising approximately 28% of vinyl acetate and having an MFI of the order of 3 g/10 min.

Evazole is an EVA copolymer of low molecular weight from Arkema.

Primol 352 is a mineral oil, the kinematic viscosity of which at 40° C. is 70 mm²/sec.

Noram M2C is a surfactant from CECA of methyidicocoamine type.

After the mixing stage, powder compositions are obtained in all cases, the flowability of which is very good and the density of which has been increased with respect to the density of the initial CNT powder (resulting from the synthesis but also obtained after blending).

The particle size of these powders is shown in Table 6. The particle size measurements were carried out by the dry route with a Malvern Mastersizer particle sizer taking (1.45; 0.100) as reference indices for the CNTs. It should be noted that, by the dry route, conveying the powder under compressed air has a tendency to reduce the size of the particles and to increase the amount of fines, this being the case for each powder. The mean size D₅₀ of the particles of the CNT+DER 332 powder is 200 μm and the level of fines (<40 μm) is less than 4% (measured by dry sieving on a vibrating sieve), whereas its D₁₀ is 42 μm.

TABLE 6

| Composition | D₅₀ (μm) | D₁₀ (μm) |
|---|---|---|
| Blended control CNT | 61 | 14.7 |
| CNT/HT121 | 146 | 15.6 |
| CNT/Vultac TB7 | 107 | 13.9 |
| CNT/35BA320 | 165 | 31.0 |
| CNT/Primol 352 | 266 | 66.4 |
| CNT/DER 332 | 185 | 42.1 |
| CNT/Evazole | 241 | 50.9 |
| CNT/PAA GE1903 | 253 | 73.2 |
| CNT 1a | 354 | 56.5 |

Dₓ the mean apparent diameter of x% of the population of the particles.

4% of CNT/DER332 (50/50) mixture prepared above is redispersed in 96% of DER 332 epoxy resin with mechanical stirring and then via an ultrasound probe for 30 minutes. DER 332 is subsequently added so as to bring the level of CNT to 0.16% in the final composition.

A comparative mixture containing 98% of DER 332 and 2% of CNT is prepared with mechanical stirring and is then stirred via an ultrasound probe for 30 minutes. DER 332 is subsequently added so as to again bring the level of CNT to 0.16% in the final composition.

Samples of each of the mixtures are subsequently observed under a microscope in order to evaluate the dispersion, as illustrated below. At the same magnification, it is found that the dispersion of the powder of the composition in epoxy resin according to the invention is improved with respect to the dispersion of CNT powder alone in epoxy resin.

For the dispersion of CNT directly in epoxy resin, the CNTs are seen to be poorly dispersed/distributed in the polymer matrix, which is reflected by the presence of numerous clusters having a size which can range up to approximately 45 μm.

For the dispersion of the pulverulent composition according to the invention in the epoxy resin, clusters of this size are not seen but only very rare clusters having a size which only exceptionally exceeds 10 μm.

### Example 7

### Powder Composition Obtained by Mixing CNT and Block Copolymer by the Solvent Route (Stage a))

The preparation is carried out of a mixture composed of CNT and block copolymer in a solvent, the description of which is given in Table 7. This mixture is stirred using an ultrasound probe for 30 minutes and then separated into two parts.

One part is filtered on a No. 2 or No. 3 sintered glass funnel until a paste having a solids content of the order of 20% is obtained. It should be noted that a portion of the copolymer placed in the starting solution is removed in the amount of solvent filtered off. In order to remove the solvent remaining in the paste thus obtained, the mixture is stirred in a Z arm mixer or in a mixer of Brabender type under temperature conditions which make possible sufficiently fast evaporation of the solvent (i.e., a temperature of approximately 40° C. with regard to acetone and of approximately 80° C. with regard to toluene).

TABLE 7

| Type of copolymer | | |
|---|---|---|
| in the composition | % CNT | Solvent |
| SBM E40 | 50 | Acetone or Toluene |
| MAM M22 | 50 | Acetone or Toluene |
| SBM E20 | 50 | Acetone or Toluene |
| SBM A250 | 30 | Acetone or Toluene |

One part of the solution is placed directly as is in the mixer of Brabender or Z arm type so as to evaporate the solvent under the temperature conditions described above. The time necessary for the evaporation of the solvent is longer according to this protocol than according to the preceding protocol.

On conclusion of the two experimental protocols described above, CNT powders charged with polymers are obtained which are similar to the powders described in Example 5, the loose bulk density of which is of the order of 6 to 9 cm³/g.

The dispersion of these powder compositions, used as masterblend, in DER 332 epoxide resin according to the procedure described in Example 6 is similar to that of the CNT powders obtained in Example 6; it is markedly improved with respect to the direct mixing of CNT and DER 332 resin for the same level of CNT.

In Table 8 below, it is shown that the dispersion of this composition in PVDF (according to the procedure of Example 3) is improved with respect to the dispersion of CNT directly in PVDF.

TABLE 8

| | CNT | | Resistivity |
|---|---|---|---|
| Final composition | (% by weight) | % Masterblend | (Ω · cm) |
| PVDF + CNT (control) | 2 | — | 193 |
| PVDF + masterblend | 2 | 4 | 125 |
| (CNT/SBM E40) | | | |

It emerges from the table that the compositions according to the invention disperse well in a polymer matrix; the distribution of the CNTs is homogeneous, which confers a lower electrical resistivity than that of compositions of the prior art.

### Example 8 (Comparative)

### Dispersion with a CNT-Based Composition Which is not in the Powder Form

The solution obtained in Example 7 containing 50% of CNT and 50% of MAM M22 in toluene is evaporated in an oven without stirring. When all the solvent has evaporated without stirring, a powder is not obtained but macroscopic pieces of CNT and copolymers of highly irregular shape and with a size of the order of one to ten millimetres are obtained.

When an attempt is made to disperse these aggregates in PVDF so as to obtain 2% of CNT in the final mixture, a nonconducting and very poorly dispersed product is obtained: macroscopically, the presence of numerous aggregates having a size close to that of the CNT pieces initially introduced (1 to 10 mm) is observed.

### Example 9

### Mixtures of CNT with Various Compounds A with Mechanical Stirring

Use is made of a powder mixer with a working volume of 16 litres of Hosokawa Nauta Minimix 020-FFC-50 type into which one of the compounds A (or a solution comprising the compound A) will be injected by virtue of peristaltic pumps with a power suited to the viscosity of the product to be injected, according to Scheme 1 below, to carry out stage a).

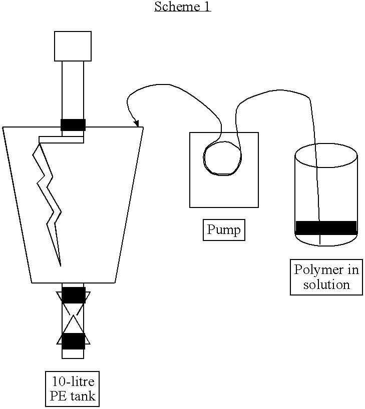

The operation is carried out according to the protocol described below:
Charging the CNT powder to the mixer via the hatch;
Starting the stirring at the maximum rate;
Mixing the powders for 5 min;
Injecting the compound A or the solution comprising the compound A via 2 peristaltic pumps. Introduction takes place via 2 branch pipes on the top of the mixer.
The pumps are adjusted for an introduction time of approximately 30 min;
After injecting, mixing is continued for 5 min;
Emptying via the bottom valve with stirring into PE kegs.

On conclusion of this stage a), the powder can be dried in the mixer or an external oven so as to evaporate the residual solvent, if stage a) consisted in injecting a polymer solution.

In the case where stage a) consisted in injecting monomer or an entity exhibiting functional groups, such as acetic acid, it may be possible to carry out a stage b) targeted at the reaction of the entities with the CNT powder. Subsequent to this stage, it will be possible to dry the powder in order to remove the entities which have not reacted. This stage can be carried out in the mixer or in an oven. The data with regard to the various mixtures which were produced are combined in Table 9.

Kynar® 2801 and Kynar® 721 are two grades of PVDF from Arkema.
The abbreviations AA, AcA and MEK correspond respectively to acrylic acid, acetic acid and methyl vinyl ketone.
The weights are expressed in grams (g).
The speeds of the arm and screw (respectively S arm and S screw) are expressed in rev/min.
The mixing and introduction times are expressed in minutes (min).

TABLE 9a

| | Composition | CNT 10 | CNT 11 | CNT 12 | CNT 13 | CNT 14 | CNT 15 | CNT 16 | CNT 17 | CNT 18 | CNT 19 | CNT 20 |
|---|---|---|---|---|---|---|---|---|---|---|---|---|
| | CNT weight | 1500 | 1500 | 1500 | 1500 | 500 | 500 | 1500 | 500 | 500 | 1500 | 1500 |
| | Compound | SBM | SBM | DV | PEO | Kynar | Kynar | MAM | AA 2 g | AcA | Epoxy | Amino |
| | A | E 40 | E 40 | 1256 | | 2801 | 721 | M22N | AZDN | | LY 556 | 11 |
| | Weight of | 4286 | 4286 | 6000 | 6622 | 500 | 500 | 5140 | 2000 | 500 | 1875 | 1500 |
| | compound A | | | | | | | | | | | |
| | and solution | | | | | | | | | | | |
| | % Solution | 35% | 35% | 25% | 5% | | | 25% | | | 80% | |
| | and name of | MEK | Tol | H₂O | H₂O | | | MEK | | | MEK | |
| | the solvent | | | | | | | | | | | |
| | used | | | | | | | | | | | |
| | Weight of | 1500 | 1500 | 1500 | 331 | 500 | 500 | 1285 | 2000 | 500 | 1500 | 1500 |
| | compound A | | | | | | | | | | | |
| | % CNT | 50 | 50 | 50 | 82 | 50 | 50 | 53.8 | 20 | 50 | 50 | 50 |
| Operating | S arm | 10 | 10 | 10 | 10 | 10 | 10 | 10 | 10 | 10 | 10 | 10 |
| Conditions | S screw | 300 | 300 | 300 | 300 | 300 | 300 | 300 | 300 | 300 | 300 | 300 |
| | Mixing time | 5 | 5 | 5 | 5 | 5 | 5 | 5 | 5 | 5 | 5 | 5 |
| | Introduction | 27 | 27 | 25 | 180 | | | 100 | 16 | 13 | 20 | |
| | time | | | | | | | | | | | |
| | Mixing time | 5 | 5 | 5 | 360 | 15 | 15 | 5 | 5 | 5 | 5 | 5 |

TABLE 9b

| Name | Density (g/ml) |
|---|---|
| Reference CNT | 0.1 |
| CNT 10 | 0.32 |
| CNT 11 | 0.32 |
| CNT 12 | 0.37 |

CNT 10 is dried for 4 hours at 80° C. in an oven. A particle size determination is carried out by dry sieving in comparison with the starting CNT. The fines at 50 μm are 0.2% for the crude CNT and 0.37% for the coated product. Graph 1 shows the particle size distribution of the product.

A shift in the mean diameter from 400 μm towards 200 μm is observed.

The CNT 10 is used as a mixture in polycarbonate in comparison with the reference CNT before modification according to the invention.

The polycarbonate used is Makrolon 2207 from Bayer, with an MFI (g/10 min) equal to 38 at 300° C. under a load of 1.2 kg. The polycarbonate is mixed with the equivalent of 2% of CNT originating from the reference CNT or from the CNT 10. Mixing is carried out on a twin-screw microextruder from DSM at 240° C. with a screw speed of 100 revolutions per minute and a mixing time of 8 min to achieve homogeneity of the mixture and stabilization of the mixing torque.

The samples are subsequently subjected to hot compression moulding in the form of sheets with a thickness of 2 mm at a temperature of 240° C. using a cycle of 5 minutes of flow and then 2 minutes under 240 bar before cooling in the press for 30 min, the heating being halted, and then cooling outside the press under a load of 12 kg.

The electrical conductivity of the samples is measured according to Example 3. The results are given in Table 10.

TABLE 10

| | Resistivity in the Makrolon 2207 PC |
|---|---|
| | mixture comprising 2% of CNT |
| | (ohm · cm) |
| Reference CNT | 323 |
| CNT 10 | 13 |

It emerges from the table that the composition according to the invention disperses well in a polymer matrix; the distribution of the CNTs is homogeneous, which confers a lower electrical resistivity than that of the composition of the prior art.

The CNT 12 is dried for 2 hours at 80° C. under vacuum. A particle size determination is carried out by dry sieving in comparison with the starting CNT. The fines at 50 μm are 0.2% for the crude CNT and 0.07% for the coated product. Graph 2 shows the particle size distribution of the product.

A shift in the mean diameter from 400 μm towards 200 μm is observed.

The starting CNT 12 is dried for 4 hours at 100° C. After this stage, the amount of polymer which can be extracted from the mixture by washing is determined. 10 g of dried product are weighed out and introduced into 250 ml of demineralized water.

Stirring is allowed to take place and the suspension is filtered through a filter paper. Extraction is carried out 4 times, i.e. 1 litre of water per 5 g of polymer to be extracted. The results are combined in Table 11.

TABLE 11

| | | | | | Drying at |
|---|---|---|---|---|---|
| | | | | | 100° C. |
| | | | | Filtrate | Weight of |
| Washing | Washing | Weight of | Filtration | Weight | PAA extracted |
| operation | ml | water (g) | time (min) | (g) | (g) |
| | 0 | | | | |
| 1 | 250 | 250.1 | 4 | 223.4 | 2.34 |
| 2 | 500 | 251.1 | 20 | 242.1 | 0.24 |
| 3 | 750 | 250.1 | 40 | 249.4 | 0.25 |
| 4 | 1000 | 250.3 | 40 | 252.8 | 0.12 |

A solids content at 100° C. is carried out on the filtrate in order to evaluate the amount of polymer extracted.

Extraction made it possible to remove only 60% of the polymer and an asymptote is reached.

It can be estimated that 20 to 30% of polymer has remained bonded to the CNT (i.e., approximately 50% of the polymer initially introduced), as illustrated in Graph 3.

At the end of stage a), the CNT 17 and the CNT 18 are tested, either as is, or after drying for 2 hours at 80° C. under vacuum, or after a stage b) carried out for 4 hours at 64° C. followed by 70 minutes at 125° C., then followed by drying for 2 hours at 80° C. under vacuum. The characteristics of the powders and the electrical properties after dispersion of the products in PVDF according to the particulars of Example 3 are combined in Tables Nos. 12 and 13.

TABLE No 12

| | | | Loose | Volume per |
|---|---|---|---|---|
| | | | density | 1 g of |
| Composition | Treatment | % CNT | (g/ml) | pure CNT |
| CNT, pure | | 100 | 0.098 | 10.3 |
| | a) (Hosokawa outlet) | 20 | 0.604 | 8.3 |
| CNT 17 | a), dried | 78.9 | 0.168 | 7.5 |
| | (a) + b)) | 40.3 | 0.155 | 16.0 |
| | a) (Hosokawa outlet) | 50.0 | 0.213 | 9.4 |
| CNT 18 | a), dried | 85.4 | 0.119 | 9.9 |
| | (a) + b)) | 51.3 | 0.116 | 16.8 |

TABLE No 13

| | | | Resistivity in | |
|---|---|---|---|---|
| | | | a mixture comprising | Volume (ml) |
| | | | 2% of CNT in PVDF | per 1 g |
| | Treatment | % CNT | (ohm · cm) | of CNT |
| CNT, | — | 100 | 209 | 10.3 |
| reference | | | | |
| CNT 17 | (a) + b)) | 40.3 | 61 | 16 |
| CNT 18 | (a) + b)) | 51.3 | 3.5 | 16.8 |

It emerges from the table that the compositions according to the invention disperse well in a polymer matrix; the distribution of the CNTs is homogeneous, which confers a lower electrical resistivity than that of compositions of the prior art.

1. Process for producing a pulverulent composition comprising from 20% to 95% of CNT carbon nanotubes (CNT), comprising the following steps:
a) admixing the CNTs with at least one compound A,
b) optionally heat treating said admixture,
c) optionally purifying and/or separating the composition from the reactants for the purpose of its recovery,
wherein the mixture on completion of each of steps a), b) and c) remains in the solid powder form,
and wherein the compound(s) A is (are) a monomer, a mixture of monomers, a molten polymer or a blend of molten polymers, a solution of monomer(s) and/or of polymer(s) in a solvent, a blend of polymers in solution in one or more monomers, a nonreactive entity of oil type or of plasticizer type, an emulsifying or surface-active agent, a coupling agent and/or a carboxylic acid.

2. Process according to claim 1, wherein the pulverulent compositions comprise from 35 to 90% of CNT.

3. Process according to claim 1, wherein the pulverulent compositions comprise from 45 to 90% of CNT.

4. Process according to claim 1, wherein the compound(s) A is (are) in the liquid form.

5. Process according to claim 1, wherein the compound(s) A is (are) in the solid form.

6. Process according to claim 1, wherein the compound(s) A is (are) in the gas form.

7. Process according to claim 1, wherein several compounds A of different physical form are employed.

8. Process according to claim 1, wherein the compound(s) A is selected from the group consisting of (meth)acrylic monomers, acrylic acid, olefinic monomers, ethylene, propylene, butene, hexane, 1-octene, diene monomers, butadiene, vinyl monomers, vinyl chloride, vinylidene monomers, vinylidene chloride, vinylaromatic monomers, styrene monomers, amino acids, lactams, carboxylic monomers, their salts and their anhydrides, vinyl esters of saturated or unsaturated carboxylic acids, vinyl acetate, monomers of epoxy resin type which can be polymerized by ring opening, bisphenol A diglycidyl ether, and mixtures thereof.

9. Process according to claim 1, wherein it comprises a stage b) with (co)polymerization of the compound(s) A.

10. Process according to claim 1, wherein the compound(s) A is (are) selected from the group consisting of polystyrene (PS), polyolefins, polyamides, poly(methyl methacrylate) (PMMA), polyethylene terephthalate (PET), polyethersulfones (PESs), polyphenylene ether (PPE), polyetheretherketones (PEEKs), poly(vinyl chloride) (PVC), polv(vinylidene fluoride) (PVDF), poly(ester)urethanes, copolymers having polyamide blocks and polyether blocks (PEBA), polyetheresteramides, polyetheresters, polystyrene-co-polybutadiene-co-polystyrene (SBS), polystyrene-co-polyisoprene-co-polystyrene (SIS), polystyrene-co-polyethylene butadiene-co-styrene (SEBS), polystyrene-co-polybutadiene (SB), polystyrene-co-polybutadiene-co-poly(methyl methacrylate) (SBM), SBuAS (polystyrene-co-poly(butyl acrylate)-co-polystyrene), (poly(methylmethacrylate-co-poly(butylacrylate)-co-poly(methylmethacrylate) (MBuAM) block copolymers, and polymers comprising functional groups of epoxide and/or glycidyl ether type.

11. Process according to claim 1, wherein the compound A is a polymer in solution in a solvent resulting from the polymerization or copolymerization of a (meth)acrylic acid monomer.

12. Process according to claim 11, in which the polymer is a copolymer of (meth)acrylic acid and of an oxyalkylenated monomer.

13. Process according to claim 1, wherein the compound A is a polymer in solution in a solvent resulting from the polymerization of alkyl (meth)acrylate with styrene and/or butadiene.

14. Process according to claim 1, wherein the compound(s) A is (are) chosen from surfactants, nonreactive entities of oil type or of plasticizer type, coupling agents and/or a carboxylic acid.

15. Process according to claim 1, wherein the compound(s) A is (are) acetic acid, acrylic acid and/or methacrylic acid.

16. Pulverulent composition made by the process of claim 1.

17. Composition according to claim 16, wherein the pulverulent is composed of particles having a mean size which is less than or equal to 1 mm, and wherein at most 10% of the particles have a size of less than 40 μm.

18. Composition according to claim 16, in which up to 50 parts by weight of the CNTs are replaced by one or more other pulverulent fillers.

19. A modifier polymer composition comprising a polymer and the composition of claim 16 as reinforcing agent and/or as modifier of the conducting and thermal properties.

20. The modified polymer of claim 19 comprising:
packagings for electronic components,
structural components for motor vehicles, trains and aircraft,
medical instruments,
fuel lines,
antistatic coatings,
adhesive materials,
thermistors,
electrodes.
